(19) United States
(12) Patent Application Publication
(10) Pub. No.: US 2026/0082135 A1
(43) Pub. Date: Mar. 19, 2026

(54) CONTROL APPARATUS, IMAGING SYSTEM, CONTROL METHOD, AND STORAGE MEDIUM

(71) Applicant: CANON KABUSHIKI KAISHA, Tokyo (JP)

(72) Inventor: Hiroki OKINO, Tokyo (JP)

(21) Appl. No.: 19/266,267

(22) Filed: Jul. 11, 2025

(30) Foreign Application Priority Data
Sep. 13, 2024 (JP) 2024-159080

(51) Int. Cl. H04N 23/90; G06F 3/14; H04N 23/63; H04N 23/73

(52) U.S. Cl. CPC H04N 23/90; G06F 3/14; H04N 23/632; H04N 23/73

(57) ABSTRACT

A control apparatus for an imaging system for capturing background images displayed on a display apparatus by using a plurality of image pickup apparatuses including a first image pickup apparatus and a second image pickup apparatus includes one or more processors that operate to cause the display apparatus to display a first background image corresponding to a first position and orientation of the first image pickup apparatus and a second background image corresponding to a second position and orientation of the second image pickup apparatus, and acquire a start instruction from a user to start display of the second background image on the display apparatus while the first background image is being displayed on the display apparatus. The one or more processors operate to start the display of the second background image on the display apparatus according to the start instruction.

### BACKGROUND

### Field of the Technology

The present disclosure relates to one or more embodiments of a control apparatus, an imaging system, a control method, and a storage medium.

### Description of the Related Art

Japanese Patent Application Laid-Open No. 2023-118468 discloses a method (in-camera VFX) for acquiring a visual effects (VFX) video (or image) without combining a background image with a live-action image, by imaging an object against a background image according to a position and orientation of a camera (image pickup apparatus).

In the in-camera VFX, in a case where the same scene is captured using a plurality of cameras and a background image is varied according to the position and orientation of one camera, the position and orientation of the other cameras may not align with the background. Japanese Patent Application Laid-Open No. 2023-159708 discloses a video capturing method using a plurality of cameras by displaying, on the background in a time-division manner, a plurality of background videos corresponding to the position and orientation of respective cameras, and by synchronizing the display timing of each background video with the exposure timing of the corresponding camera.

However, in order to increase the number of cameras, the method disclosed in Japanese Patent Application Laid-Open No. 2023-159708 may reduce the exposure time of each camera and the display time of the background image in accordance with the increase in the number of cameras. Furthermore, if the exposure time of the camera is reduced, it becomes difficult to produce smooth captured video.

### SUMMARY

One or more embodiments of a control apparatus according to one or more aspects of the present disclosure for an imaging system configured to capture background images displayed on a display apparatus by using a plurality of image pickup apparatuses including a first image pickup apparatus and a second image pickup apparatus may include one or more memories storing instructions, and one or more processors that, upon execution of the instructions, operate to cause the display apparatus to display a first background image corresponding to a first position and orientation of the first image pickup apparatus and a second background image corresponding to a second position and orientation of the second image pickup apparatus, and acquire a start instruction from a user to start display of the second background image on the display apparatus while the first background image is being displayed on the display apparatus. The one or more processors may operate to start the display of the second background image on the display apparatus according to the start instruction. One or more embodiments of an imaging system utilizing the above control apparatus also constitutes another aspect of the present disclosure. A storage medium storing a program that causes a computer to execute the above one or more control methods also constitutes another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram of an imaging system according to each example.

FIG. 2 is a block diagram of an image pickup apparatus according to each example.

FIG. 3 is a block diagram of a main-camera selecting apparatus according to each example.

FIG. 4 is a flowchart illustrating an operation of the main-camera selecting apparatus according to Example 1.

FIG. 5 is a schematic diagram illustrating a display example of a display apparatus according to Example 1.

FIG. 6 is a flowchart illustrating an operation of the main-camera selecting apparatus according to Example 2.

FIG. 7 illustrates an example of a display pattern and an exposure pattern according to Example 2.

FIG. 8 illustrates an example of a display pattern and an exposure pattern according to Example 2.

FIG. 9 is a flowchart illustrating an operation of the main-camera selecting apparatus according to Example 3.

FIG. 10 illustrates an example of information on a switching order of a main camera according to Example 3.

FIG. 11 illustrates an example of a display pattern and an exposure pattern according to Example 3.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the present disclosure. Although each embodiment includes a plurality of features, not all of these features are essential to the present disclosure, and the plurality of features may be combined arbitrarily. In the accompanying drawings, identical or similar components are denoted by the same reference numerals, and redundant descriptions will be omitted.

### Configuration Example of Virtual Studio

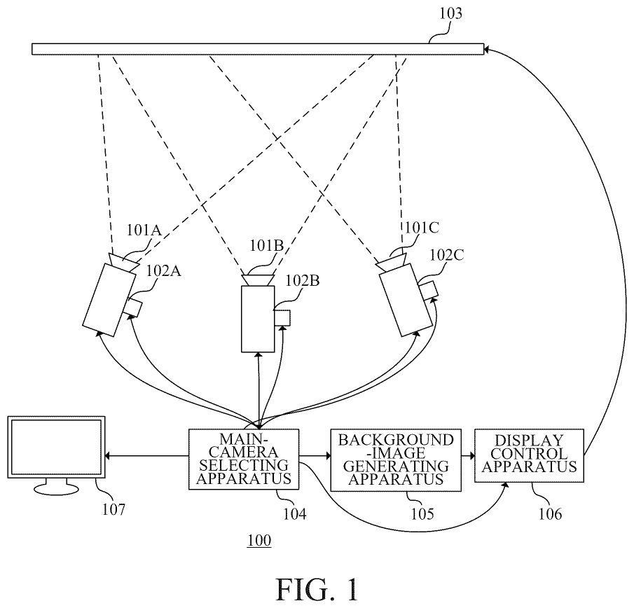

First, with reference to FIG. 1, a configuration example of an imaging system (virtual studio) 100 according to each example will be described. FIG. 1 is a schematic diagram of the imaging system 100. In the imaging system 100, a plurality of image pickup apparatuses (cameras 101A to 101C) capture an in-camera VFX video by imaging a real object against an image displayed on a large display apparatus 103, which is also referred to as an LED wall, for example. Any one of the cameras 101A to 101C illustrated in FIG. 1 serves as a first image pickup apparatus, and any one of the other two cameras serves as a second image pickup apparatus. The imaging system 100 is not limited to a configuration which includes three image pickup apparatuses, and may include two, or four or more, image pickup apparatuses.

Position-and-orientation detecting apparatuses 102A to 102C are respectively attached to the cameras 101A to 101C, and detect the position and orientation (first position and orientation, second position and orientation) of the corresponding cameras. The position-and-orientation detecting apparatuses 102A to 102C also output information on the position and orientation of the cameras 101A to 101C to a main-camera selecting apparatus 104. Since the basic configuration of the position-and-orientation detecting apparatuses 102A to 102C is known as a camera tracking system, a detailed description thereof will be omitted. For example, the position-and-orientation detecting apparatuses 102A to 102C may include cameras for position and orientation detection, may capture images of markers, which are not illustrated in FIG. 1 and whose absolute positions are known, and may detect the position and orientation of the corresponding cameras based on positions of the markers included in the image captured by the cameras for position and orientation detection. The position and orientation of the cameras 101A to 101C can be detected by any known method.

The main-camera selecting apparatus 104 selects a main camera from among the cameras 101A to 101C by a method to be described later. The main-camera selecting apparatus 104 also outputs information on the position and orientation of the main camera to a background-image generating apparatus 105. The main-camera selecting apparatus 104 further outputs an image captured by the main camera to a display apparatus (image display unit) 107. In addition, the main-camera selecting apparatus 104 controls the start and end of capturing of the in-camera VFX video (moving images). The main-camera selecting apparatus 104, together with the background-image generating apparatus 105 and a display control apparatus 106 to be described later, constitutes a control apparatus of the imaging system 100, which captures respective background images displayed on the display apparatus 103 using the cameras 101A to 101C.

The background-image generating apparatus 105 renders a three-dimensional model in a preset virtual space in accordance with the position and orientation of the main camera selected by the main-camera selecting apparatus 104, and generates a CG background image at a predetermined frame rate. In a case where an imaging direction of the main camera is not directed straight toward the display apparatus 103, the background-image generating apparatus 105 applies a coordinate transformation (deformation processing) which is necessary to display the background image on the display apparatus 103. The background-image generating apparatus 105 outputs the generated background image to the display control apparatus 106.

The display control apparatus 106 causes the background image to be displayed on the display apparatus 103, which is arranged in a real space, in synchronization with an imaging timing of the main camera. In a case where the display apparatus 103 is composed of a plurality of display panels, the display control apparatus 106 divides the background image in accordance with the respective display panels before displaying it.

The display apparatus 107 is, for example, a monitor, and displays an image captured by the main camera based on an operation of the main-camera selecting apparatus 104, which will be described later. The display apparatus 107 also displays a UI for assisting various input instructions by a user to the main-camera selecting apparatus 104.

In addition, synchronization signals are supplied from the main-camera selecting apparatus 104 to the cameras 101A to 101C, the position-and-orientation detecting apparatuses 102A to 102C, the background-image generating apparatus 105, and the display control apparatus 106. By controlling an operation timing of each apparatus in accordance with a reference clock, synchronization between the exposure timing of the cameras 101A to 101C and the display timing of the display apparatus 103 is achieved. A technique for synchronizing operations among apparatuses based on the reference clock is known, for example, as generator locking (Genlock), and a detailed description thereof will be omitted. (Configuration Example of Camera 101A)

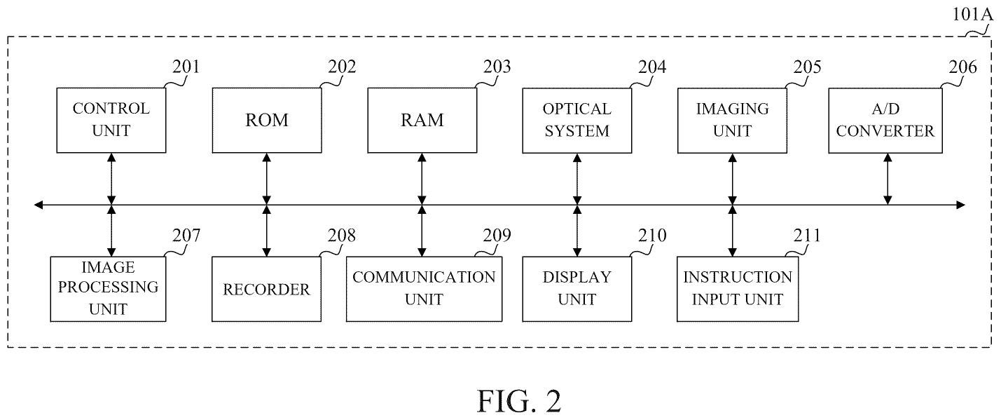

Next, with reference to FIG. 2, a configuration example of the camera 101A will be described. The camera 101B and the camera 101C may have the same configuration as the camera 101A. FIG. 2 is a block diagram which illustrates a functional configuration example of the camera 101A.

A control unit 201 is, for example, a central processing unit (CPU). The control unit 201 reads a control program for the respective blocks included in the camera 101A from a read only memory (ROM) 202, which will be described later, and loads and executes the program in a random access memory (RAM) 203, which will also be described later. Thus, the control unit 201 controls the operations of the respective blocks included in the camera 101A. The control unit 201 also controls the respective blocks of the camera 101A based on a synchronization signal supplied via a communication unit 209. As a result, synchronization of an operation with an external apparatus can be achieved.

The ROM 202 is a non-volatile memory which is electrically erasable and recordable, and stores not only operation programs for the respective blocks included in the camera 101A but also parameters and the like necessary for the operation of each block. The RAM 203 is a rewritable volatile memory, and is used for loading programs executed by the control unit 201 and the like, and for temporarily storing data generated or otherwise obtained during the operation of the respective blocks included in the camera 101A.

An optical system 204 is composed of a lens unit which includes a zoom lens and a focus lens, and forms an image of an object on an imaging plane of an imaging unit 205, which will be described later. The imaging unit 205 is an image sensor such as a charge coupled device (CCD) sensor or a complementary metal-oxide-semiconductor (CMOS) sensor. The imaging unit 205 photoelectrically converts an optical image formed on the imaging plane by the optical system 204, and outputs the resulting analog image signal to an A/D converter 206.

The A/D converter 206 converts an input analog image signal into digital image data. The digital image data which is output from the A/D converter 206 is temporarily stored in the RAM 203.

An image processing unit 207 performs various types of image processing on image data stored in the RAM 203. More specifically, the image processing unit 207 applies various image processing operations for developing, displaying, and recording the digital image data, such as demosaicing processing, white balance correction processing, and gamma correction processing. In addition, the image processing unit 207 applies various image processing operations for enhancing image quality of the digital image data, such as noise reduction processing using spatial filters or composition of multiple image data frames.

A recorder 208 records data which includes image data in a built-in recording medium. The communication unit 209 communicates image data and synchronization signals with an external apparatus via a wired or wireless connection. A display unit 210 includes a display device such as a liquid crystal display (LCD), and displays, on the display device, images stored in the RAM 203 or images recorded in the recorder 208. The display unit 210 also displays, for example, an operation user interface for receiving instructions from a user. An instruction input unit 211 is an input interface which includes various physical operation members such as a touch panel or a shutter button, and receives user instructions.

### Configuration Example of Main-Camera Selecting Apparatus

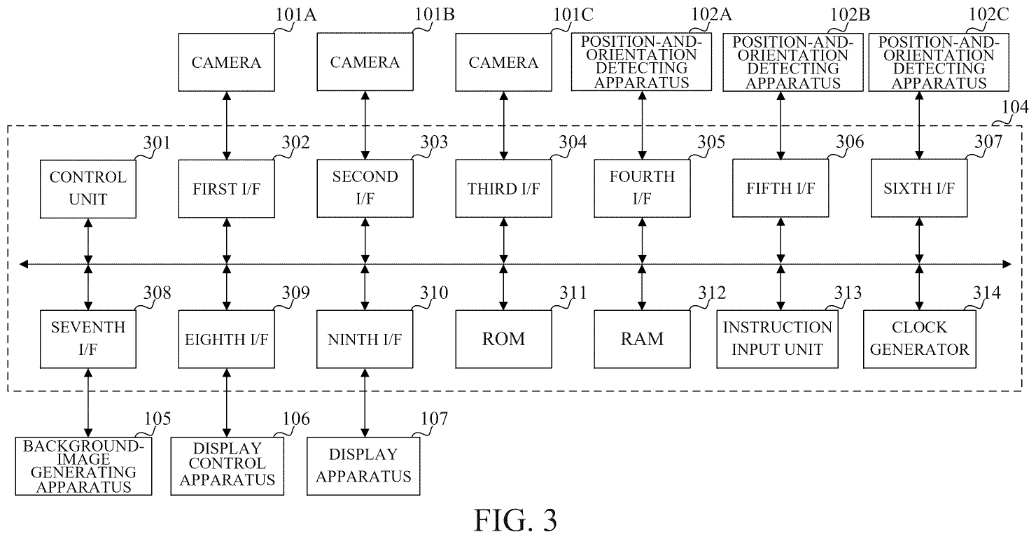

Next, with reference to FIG. 3, the main-camera selecting apparatus 104 will be described. FIG. 3 is a block diagram which illustrates a functional configuration example of the main-camera selecting apparatus 104. The main-camera selecting apparatus 104 can be implemented, for example, using a computer device.

A control unit 301 is, for example, a CPU, and realizes the functions of the main-camera selecting apparatus 104 by loading one or more application programs stored in a ROM 311 into a RAM 312 and executing them. The control unit 301 controls an operation timing of the main-camera selecting apparatus 104 in accordance with a synchronization signal supplied from a clock generator 314. Further, as will be described later, the control unit 301, together with the display control apparatus 106, constitutes a controller (one or more processors) for causing a first background image corresponding to a first position and orientation of the first image pickup apparatus and a second background image corresponding to a second position and orientation of the second image pickup apparatus to be displayed on the display apparatus 103.

The first I/F 302 to the ninth I/F 310 are communication interfaces for connecting external devices. In each example, the camera 101A is connected to the first I/F 302, the camera 101B is connected to the second I/F 303, and the camera 101C is connected to the third I/F 304. In each example, the position-and-orientation detecting apparatus 102A is connected to the fourth I/F 305, the position-and-orientation detecting apparatus 102B is connected to the fifth I/F 306, and the position-and-orientation detecting apparatus 102C is connected to the sixth I/F 307. In each example, the background-image generating apparatus 105 is connected to the seventh I/F 308, the display control apparatus 106 is connected to the eighth I/F 309, and the display apparatus 107 is connected to the ninth I/F 310. The first I/F 302 to the ninth I/F 310 conform to standards corresponding to the types of external apparatuses connected and types of signals communicated. For convenience of illustration, although the main-camera selecting apparatus 104 and each external apparatus are illustrated as being connected via a single I/F, they may be connected via a plurality of I/Fs.

The control unit 301 reads a control program for the respective blocks included in the main-camera selecting apparatus 104 from the ROM 311, which will be described later, and loads and executes the program in the RAM 312, which will also be described later. Thus, the control unit 301 controls the operations of the respective blocks included in the main-camera selecting apparatus 104. The ROM 311 stores part of the programs executed by the control unit 301 (such as a BIOS, bootstrap loader, or firmware), setting values of the main-camera selecting apparatus 104, and the like. The RAM 312 is a rewritable volatile memory, and is used for loading programs executed by the control unit 301 and the like, and for temporarily storing data generated or otherwise obtained during the operation of the respective blocks included in the main-camera selecting apparatus 104.

An instruction input unit (one or more processors) 313 includes a plurality of input devices operable by a user, such as a keyboard, a mouse, or a touchpad. For example, the instruction input unit 313 acquires (receives) a start instruction from the user to cause the display apparatus 103 to start displaying the second background image while the first background image is being displayed on the display apparatus 103. A clock generator 314 generates synchronization signals (clocks) for synchronizing the operations of the main-camera selecting apparatus 104 and external apparatuses, including the cameras 101A to 101C, the position-and-orientation detecting apparatuses 102A to 102C, the background-image generating apparatus 105, and the display control apparatus 106. The main-camera selecting apparatus 104 selects the main camera from among the cameras 101A to 101C, and outputs an image captured by the main camera and information on the position and orientation of the main camera to various external apparatuses.

Hereinafter, the switching operation of the main camera by the main-camera selecting apparatus 104 will be described in each example.

### Example 1

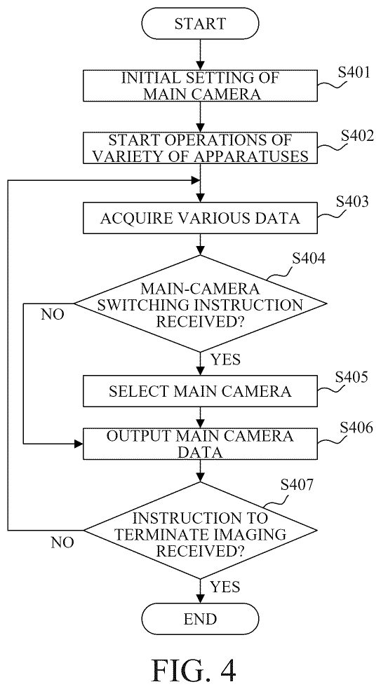

First, with reference to FIG. 4, the switching operation of the main camera by the main-camera selecting apparatus 104 in Example 1 of the present disclosure will be described. FIG. 4 is a flowchart which illustrates the operation of the main-camera selecting apparatus 104 in this example.

The operation illustrated in FIG. 4 is executed starting from the imaging start of the in-camera VFX video (moving images) by the cameras 101A to 101C. Here, the video may be either for recording or for display. The video for display may be, for example, a video for performing live-view display in an imaging standby state on the display unit 210 of the camera 101A or on the display apparatus 107. The imaging start of the in-camera VFX video is executed, for example, when the user issues an instruction of the imaging start to the main-camera selecting apparatus 104 via the instruction input unit 313. In the following description, the operations executed by the main-camera selecting apparatus 104 are actually realized by the control unit 301 executing an appropriate application program.

In the following description, the processing of the main-camera selecting apparatus 104 in steps S403 to S407 is performed for each frame based on a synchronization signal supplied from the clock generator 314. One frame refers to one frame among the video frames captured by the cameras 101A to 101C at a predetermined frame rate, or one frame among the background image frames displayed by the display apparatus 103 at a predetermined frame rate.

First, in step S401, the main-camera selecting apparatus 104 sets one of the cameras 101A to 101C as the initially set main camera. For example, in this case, the camera 101A is set as the main camera by default. The initially set main camera may be selectable by the user.

Next, in step S402, the main-camera selecting apparatus 104 causes each of the cameras 101A to 101C to start an imaging operation. The main-camera selecting apparatus 104 also causes each of the position-and-orientation detecting apparatuses 102A to 102C to start a position-and-orientation detecting operation of the corresponding cameras 101A to 101C. Furthermore, when recording of in-camera VFX video is to be performed, the main-camera selecting apparatus 104 causes each of the cameras 101A to 101C to start recording captured images (first captured image, second captured image). Whether the recording is to be performed or not may be selectable by the user.

Next, in step S403, the main-camera selecting apparatus 104 acquires various data inputs from the external apparatuses. More specifically, the main-camera selecting apparatus 104 acquires captured images (first captured image, second captured image), each captured by one of the cameras 101A to 101C. The main-camera selecting apparatus 104 also acquires information on the position and orientation (first position and orientation, second position and orientation) of the cameras 101A to 101C from the position-and-orientation detecting apparatuses 102A to 102C, respectively.

Next, in step S404, the main-camera selecting apparatus 104 determines whether a main camera switching instruction has been received from the user via the instruction input unit 313. The main camera switching instruction includes information specifying which camera is to be switched to. In a case where it is determined that the main camera switching instruction has been received, the process proceeds to step S405. On the other hand, in a case where it is determined that no main camera switching instruction has been received, the process proceeds to step S406.

In step S405, the main-camera selecting apparatus 104 sets (selects) one of the cameras 101A to 101C as the main camera in accordance with the main camera switching instruction received in step S404. The setting of the main camera is performed by the control unit 301 changing the value of a variable stored in the RAM 312, the variable indicating which camera is the main camera. For example, in a case where the camera 101A is to be set as the main camera, the value of the variable is set to 0; in a case where the camera 101B is to be set as the main camera, the value of the variable is set to 1; and in a case where the camera 101C is to be set as the main camera, the value of the variable is set to 2.

Next, in step S406, the main-camera selecting apparatus 104 outputs various data related to the main camera to the external apparatuses. More specifically, the main-camera selecting apparatus 104 outputs information on the position and orientation of the main camera, among the information on the position and orientation of the cameras 101A to 101C which has been input in step S403, to the background-image generating apparatus 105. The background-image generating apparatus 105 renders a background image as CG using the information on the position and orientation of the main camera which has been input from the main-camera selecting apparatus 104, and outputs the rendered image to the display control apparatus 106. The display control apparatus 106 then outputs the background image which has been input from the background-image generating apparatus 105 to the display apparatus 103 for display. The main-camera selecting apparatus 104 also outputs the captured image of the main camera, among the captured images of the cameras 101A to 101C acquired in step S403, to the display apparatus 107 for display.

Next, in step S407, the main-camera selecting apparatus 104 determines whether an instruction to terminate imaging has been received from the user via the instruction input unit 313. In a case where it is determined that the instruction to terminate imaging has been received, the imaging operations and recording operations of the cameras 101A to 101C, as well as the position and orientation detecting operations of the position-and-orientation detecting apparatuses 102A to 102C, are terminated, and the flow of FIG. 4 is ended. On the other hand, in a case where it is determined that no instruction to terminate imaging has been received, the process proceeds to step S403.

In this manner, the main-camera selecting apparatus 104 can switch, at a timing corresponding to the main camera switching instruction from the user, an image corresponding to the position and orientation of one camera displayed on the display apparatus 103 to an image corresponding to the position and orientation of another camera. That is, the main-camera selecting apparatus 104 can terminate the display of a background image corresponding to one of the cameras 101A to 101C and start the display of a background image corresponding to another camera. As a result, the user can capture a video in a desired cut (video of a desired camera during a desired imaging period) in which the background image is consistent with the position and orientation of the camera.

Further, through the above-described flow, the main-camera selecting apparatus 104 can display, on the display apparatus 107, a captured image captured by a predetermined camera, at a time when a background image corresponding to the position and orientation of the same predetermined camera is being displayed on the display apparatus 103, regardless of the switching of the main camera. As a result, the user can more easily confirm whether a desired video is being captured by the main camera during the imaging of the in-camera VFX video, regardless of the switching of the main camera.

In the foregoing description, the background image is switched by causing the main-camera selecting apparatus 104 to input the information on the position and orientation of the main camera to the background-image generating apparatus 105. However, the background image may alternatively be switched to an image corresponding to the position and orientation of another camera by a different method.

For example, the background-image generating apparatus 105 may generate background images corresponding to the position and orientation of the cameras 101A to 101C, respectively, and may select a background image corresponding to the position and orientation of the main camera from among the plurality of background images and output it to the display apparatus 103. In this case, for example, the position-and-orientation detecting apparatuses 102A to 102C may output the information on the position and orientation of the respective cameras directly to the background-image generating apparatus 105 without passing through the main-camera selecting apparatus 104. The background-image generating apparatus 105 then generates an image corresponding to the position and orientation of each camera individually. The main-camera selecting apparatus 104, based on the setting indicating which camera is the main camera, causes the background-image generating apparatus 105 to select, from among the generated background images, the image corresponding to the main camera and to output it to the display control apparatus 106.

Even with this method, it is possible to switch the background image to be displayed on the display apparatus 103 to an image corresponding to the position and orientation of any of the cameras. However, in the method described with reference to FIG. 4, since the background-image generating apparatus 105 only needs to generate a background image corresponding to the position and orientation of the main camera, the rendering computational cost can be reduced as compared to a method in which multiple background images are generated and then one is selected.

In the foregoing description, although the main-camera selecting apparatus 104 displays only the captured image of the main camera on the display apparatus 107, the main-camera selecting apparatus 104 may be controlled to simultaneously display the captured image of the main camera and the captured images of the other cameras, with the captured image of the main camera being emphasized. The emphasis display refers to, for example, displaying the captured image of the main camera in an area larger than that of the captured images of the other cameras, or fixing a predetermined area in the screen as a display area for the captured image of the main camera and displaying it without changing the area over time.

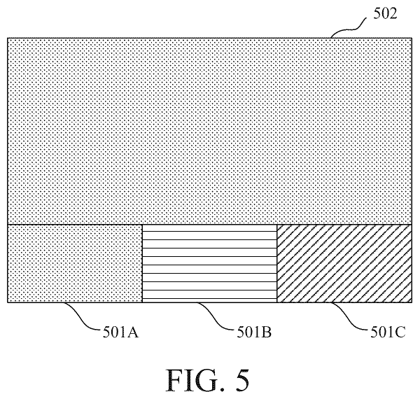

FIG. 5 is a schematic diagram which illustrates an example of an image in which the captured image of the main camera is emphasized and displayed. Areas 501A to 501C respectively indicate areas in which the captured images of the cameras 101A to 101C are reduced in size and displayed. An area 502 indicates an area in which the captured image of the main camera among the cameras 101A to 101C is displayed with a larger area than each of the areas 501A to 501C. In this case, the main-camera selecting apparatus 104, by executing an appropriate application, processes the captured images of the cameras 101A to 101C into the state illustrated in FIG. 5 based on the information on the main camera, and outputs the processed image to the display apparatus 107. By this method as well, the user can more easily confirm whether a desired video is being captured by the main camera during the imaging of the in-camera VFX video, regardless of the switching of the main camera.

In the foregoing description, the background-image generating apparatus 105 may, during rendering, identify the actual imaging range on the display surface of the display apparatus 103 based on the information on the position and orientation of the main camera and the information on the angle of view (focal length of an imaging lens) acquired from the main camera. The background-image generating apparatus 105 can identify, for example, a first imaging range of the first image pickup apparatus and a second imaging range of the second image pickup apparatus. Further, the background-image generating apparatus 105 can change the first imaging range to the second imaging range, for example, according to the start instruction from the user to start displaying the second background image on the display apparatus 103.

In addition, the background-image generating apparatus 105 may reduce a processing load of rendering by rendering the CG with lower image quality outside the imaging range than within the imaging range, or by rendering the CG limited to within the imaging range. In this case, in step S403, the main-camera selecting apparatus 104 further acquires information on the angle of view from each of the cameras 101A to 101C. In step S406, the main-camera selecting apparatus 104 outputs, in addition to the information on the position and orientation of the main camera, the information on the angle of view of the main camera to the background-image generating apparatus 105 among the information on the angle of view of the cameras 101A to 101C. The background-image generating apparatus 105 identifies the imaging range based on the information on the position and orientation of the main camera and the information on the angle of view of the main camera, and renders the CG based on the information on the position and orientation limited to within the imaging range. With this method, the main-camera selecting apparatus 104 can align the rendering range of the background image regardless of the switching of the main camera.

In the above description, the camera 101A may record, together with the captured video, information indicating whether or not the background image corresponds to the position and orientation of the camera 101A. For example, the main-camera selecting apparatus 104 can determine whether the second captured image was captured at the display time of the second background image. In this case, in step S406, the main-camera selecting apparatus 104 outputs a flag value (for example, 1) indicating that the background image corresponds to the main camera. Additionally, it outputs a flag value (for example, 0) indicating that the background image does not correspond to cameras other than the main camera. Furthermore, the camera 101A records the flag value input from the main-camera selecting apparatus 104 in the recorder 208 together with the captured image.

Accordingly, by referring to the flag value of each frame of the recorded captured video, it becomes easier to identify the period of valid video, that is, the period within the captured video which corresponds to the display period of the background image and is aligned with the position and orientation of the camera. The form of the aforementioned attached information is merely an example, and any form of attached information may be used as long as it enables identification of the period corresponding to the display period of the background image. For example, the camera 101A may attach a start flag to a frame at which the period corresponding to the background begins, and may attach an end flag to a frame at which the period ends. Similarly, the camera 101B and the camera 101C may also record the captured video together with information indicating whether or not the background image corresponds to their respective positions and orientations. In this manner, the main-camera selecting apparatus 104 can attach, for example, information indicating whether the second captured image was captured at the display time of the second background image to the second captured image.

Further, it is also possible to extract, from the captured video of the cameras 101A to 101C, a video segment corresponding to a period during which the background corresponds, by using information attached to the captured video indicating whether or not the background corresponds. That is, the main-camera selecting apparatus 104 can extract, from the second captured image, the captured image which was captured at the display time of the second background image, using information indicating whether or not the second captured image was captured at the display time of the second background image.

In this case, the image extraction processing is performed, for example, after completion of the flow illustrated in FIG. 4 (after completion of the imaging of the in-camera VFX video), by a video editing apparatus not illustrated in FIG. 1. The video editing apparatus is, for example, a computer device, and executes an appropriate application to extract a captured video corresponding to the period during which the background corresponds, based on the information attached to the captured video. For example, in a configuration in which a flag value of 1 is attached to a frame in which the background image corresponds, and a flag value of 0 is attached to a frame in which the background image does not correspond, the video editing apparatus extracts the frame having the flag value of 1. In this way, it is possible to extract the captured video of the valid period during which the background corresponds.

In the above description, the background-image generating apparatus 105 may temporarily suspend the recording operation of captured images for the cameras among the cameras 101A to 101C which are not set as the main camera. In this case, in step S405, the main-camera selecting apparatus 104 causes the newly set main camera to start the recording operation of captured images and causes the original main camera to stop the recording operation of captured images. In step S402, the main-camera selecting apparatus 104 causes only the main camera initially set in step S401 to start the recording operation of captured images. Accordingly, each of the cameras 101A to 101C can record captured images only during a valid period in which a background image corresponding to its own position and orientation is displayed.

### Example 2

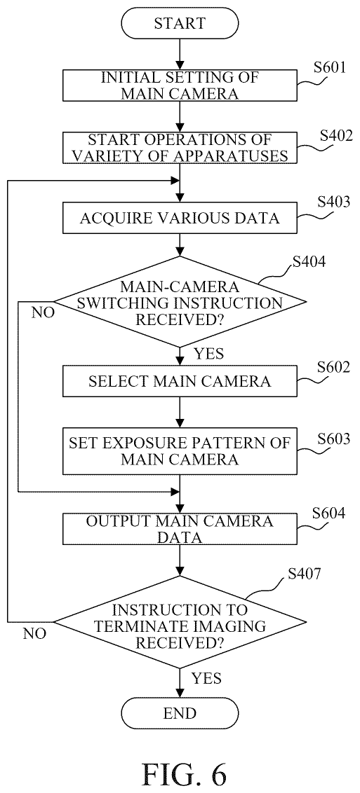

Next, with reference to FIG. 6, a description will be given of the switching operation of the main camera according to Example 2 of the present disclosure. FIG. 6 is a flowchart which illustrates the operation of the main-camera selecting apparatus 104 in this example.

In the switching operation of the main camera described in Example 1 with reference to FIG. 4, the display of the background image corresponding to the position and orientation of the newly set main camera is started according to the main camera switching instruction, and the display of the background image corresponding to the position and orientation of the previously set main camera is terminated. As a result, by connecting, in chronological order, the periods (cuts) in which the background image is aligned in the captured video of each camera after the end of imaging, it is possible to compose a sequence of scenes without any missing time.

However, if the time of switching the cuts is changed from the time of the main camera switching instruction to an earlier or later time, a period during which the background image does not match may occur in either the cut before or after the switching. Therefore, in the method of Example 1, it is difficult for the user to adjust the time of switching the cuts from the time of the main camera switching instruction after the completion of imaging.

On the other hand, in this example, a time-division display is performed on the display apparatus, and a plurality of types of background images are displayed substantially simultaneously. In addition, after the main camera switching instruction, the display of the background image corresponding to the position and orientation of the originally set main camera is not terminated for at least a predetermined period (is continued for the predetermined period), whereby it becomes possible to adjust the time of switching the cuts to a later time after the completion of imaging.

In FIG. 6, the steps which execute the operations described in FIG. 4 are denoted by the same reference numerals as those in FIG. 4, and descriptions thereof are omitted. Further, in the following description, the processing of the main-camera selecting apparatus 104 in steps S403 to S407 is performed for each frame based on the synchronization signal supplied from the clock generator 314, in the same manner as in Example 1.

First, in step S601, the main-camera selecting apparatus 104 sets one of the cameras 101A to 101C as an initially set first main camera. For example, in this case, the camera 101A is set as the main camera by default. The initially set main camera may be selectable by the user.

In step S404, the main-camera selecting apparatus 104 determines whether or not the main camera switching instruction has been issued. In a case where it is determined that the main camera switching instruction has been issued, the process proceeds to step S602. In step S602, the main-camera selecting apparatus 104 sets one of the cameras 101A to 101C as either the first main camera or the second main camera, in accordance with the main camera switching instruction received in step S404.

More specifically, the main camera is set to the one of the first main camera and the second main camera which was not set in the previous processing of step S602. For example, in a case where the camera 101A was set as the first main camera in the previous processing of step S602, in the current processing of step S602, either the camera 101B or the camera 101C is set as the second main camera. In addition, in a case where the camera 101A was set as the second main camera in the previous processing of step S602, in the current processing of step S602, either the camera 101B or the camera 101C is set as the first main camera. The setting of the first main camera and the second main camera is performed by changing, respectively, the values of variables, which indicate which cameras are the respective main cameras, held in the RAM 312 by the control unit 301.

Further, the main-camera selecting apparatus 104 updates a flag which indicates whether the corresponding camera was set as the first main camera or the second main camera in the last processing of step S602, for subsequent processing. For example, in a case where the corresponding camera is set as the first main camera in the current processing of step S602, the flag is set to 0. In a case where the corresponding camera is set as the second main camera, the flag is set to 1. By referring to the flag, the main-camera selecting apparatus 104 can determine whether the first main camera or the second main camera was set in the previous step S602. In the initial state after the start of imaging, the flag is assumed to be set to 0 in accordance with the setting of the first main camera in step S601. That is, in the first main camera switching instruction after the start of imaging, the camera designated by the main camera switching instruction is set as the second main camera.

According to the processing described later, in the first main camera, the display of the corresponding background image (corresponding to the position and orientation of the camera) is performed in a first display pattern, and imaging is performed in a first exposure pattern. In the second main camera, the display of the corresponding background image is performed in a second display pattern, and imaging is performed in a second exposure pattern.

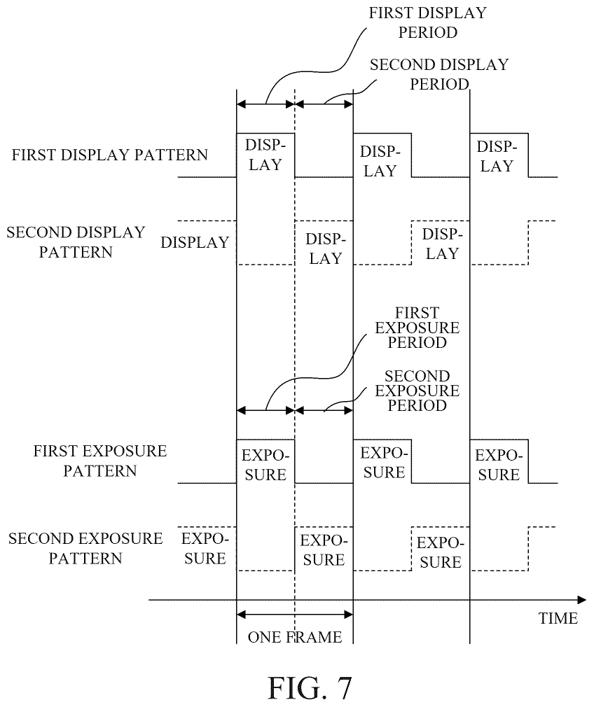

With reference to FIG. 7, the first display pattern and the second display pattern will be described. FIG. 7 is a diagram which illustrates examples of display patterns and exposure patterns. In this example, the display control apparatus 106 causes the display apparatus 103 to perform time-division display of two types of background images in non-overlapping display periods (first display period and second display period).

More specifically, the background image corresponding to the first main camera is displayed during the first display period, and the background image corresponding to the second main camera is displayed during the second display period which does not overlap with the first display period. In the example illustrated in FIG. 7, the first display period and the second display period are designed to be included within one frame period in accordance with the frame rate, and the first half of the frame is allocated as the first display period while the second half is allocated as the second display period. The first display period and the second display period are repeatedly allocated at a cycle corresponding to the frame rate (hereinafter referred to as the first display pattern and the second display pattern, respectively). Accordingly, the display apparatus 103 is capable of time-division displaying the background image corresponding to the first main camera and the background image corresponding to the second main camera. A period in which no background image is displayed may exist within one frame period.

Next, with reference to FIG. 7, a description will be given of the first exposure period and the second exposure period. The first exposure period is a period corresponding to the first display period, and, similarly to the example of the first display period, is allocated to the first half of one frame. Accordingly, during the first exposure period, the background image displayed during the first display period can be captured. The second exposure period is a period corresponding to the second display period, and, similarly to the example of the second display period, is allocated to the second half of one frame. Accordingly, during the second exposure period, the background image displayed during the second display period can be captured. The first exposure period and the second exposure period are repeatedly allocated at a cycle corresponding to the frame rate, similarly to the display period (hereinafter referred to as the first exposure pattern and the second exposure pattern, respectively). Each exposure period only needs to include the corresponding display period and exclude the non-corresponding display period, and the length of the period may differ from that of the corresponding display period. Even in this case, the background image of the corresponding display period can be captured without being superimposed with another background image.

Returning back to the description of FIG. 6. In step S603, the main-camera selecting apparatus 104 sets an exposure pattern for the camera among the cameras 101A to 101C which has been set as the first main camera or the second main camera in the immediately preceding step S602. More specifically, in a case where the corresponding camera is set as the first main camera in step S602, the main-camera selecting apparatus 104 configures itself to supply a synchronization signal for performing imaging with the first exposure pattern to the corresponding camera. On the other hand, in a case where the corresponding camera is set as the second main camera in step S602, the main-camera selecting apparatus 104 configures itself to supply a synchronization signal for performing imaging with the second exposure pattern to the corresponding camera. The synchronization signal for performing imaging with each exposure pattern will be described later.

Each of the cameras 101A to 101C is capable of performing imaging in the first exposure pattern or the second exposure pattern by performing an imaging operation in accordance with the timing based on the synchronization signal supplied from the main-camera selecting apparatus 104. Accordingly, even when the display pattern of the corresponding background image is changed due to a switch of the main camera, the first main camera and the second main camera can perform imaging of the corresponding background image. In the initial state after the start of imaging, it is assumed that the first exposure pattern is set for each of the cameras 101A to 101C.

Next, in step S604, the main-camera selecting apparatus 104 outputs respective data regarding the first main camera and the second main camera to an external apparatus. More specifically, the main-camera selecting apparatus 104 outputs, to the background-image generating apparatus 105, the information on the position and orientation of the first main camera and the information on the position and orientation of the second main camera among the information on the position and orientation of the cameras 101A to 101C which was input in step S403. The background-image generating apparatus 105 sequentially renders CGs of the background images corresponding to the respective positions and orientations, using the information on the position and orientation of the first main camera and the information on the position and orientation of the second main camera which were input from the main-camera selecting apparatus 104, and outputs the rendered images to the display control apparatus 106. The display control apparatus 106 outputs the background image corresponding to the first main camera, which was input from the background-image generating apparatus 105, to the display apparatus 103 and controls the display apparatus 103 so as to display the image in the first display pattern. The display control apparatus 106 also outputs the background image corresponding to the second main camera, which was input from the background-image generating apparatus 105, to the display apparatus 103 and controls the display apparatus 103 so as to display the image in the second display pattern.

Further, the main-camera selecting apparatus 104 outputs, to the display apparatus 107, the captured image of the camera which was newly set as the first main camera or the second main camera in the most recent processing of step S602, among the captured images of the cameras 101A to 101C acquired in step S403, and causes the image to be displayed. Thus, the main-camera selecting apparatus 104 can cause the captured image of the camera designated as the switching destination by the latest main camera switching instruction from the user to be displayed on the display apparatus 107.

The synchronization control of the first display pattern and the second display pattern, as well as the first exposure pattern and the second exposure pattern, is executed in accordance with a synchronization signal including the timings of the first half and the second half of one frame, the synchronization signal being supplied from the clock generator 314 of the main-camera selecting apparatus 104. More specifically, the clock generator 314 generates a synchronization signal indicating the timing of the first half (start of the frame) of one frame and a synchronization signal indicating the timing of the second half (after a lapse of half of one frame from the start of the frame) of one frame. Further, the main-camera selecting apparatus 104 supplies, to the display control apparatus 106, the synchronization signal indicating the timing of the first half of one frame and the synchronization signal indicating the timing of the second half of one frame, in a state in which these synchronization signals can be determined.

The display control apparatus 106 causes the display apparatus 103 to display, at a timing corresponding to the synchronization signal indicating the timing of the first half of one frame, the background image corresponding to the position and orientation of the first main camera among the background images output from the background-image generating apparatus 105. The display control apparatus 106 also causes the display apparatus 103 to display, at a timing corresponding to the synchronization signal indicating the timing of the second half of one frame, a background image corresponding to on the position and orientation of the second main camera among the background images output from the background-image generating apparatus 105. Accordingly, the display apparatus 103 can display the background image corresponding to the position and orientation of the first main camera and the background image corresponding to the position and orientation of the second main camera in the first display pattern and the second display pattern, respectively.

The main-camera selecting apparatus 104 supplies, among the synchronization signals, the synchronization signal indicating the timing of the first half of one frame to the first main camera. The first main camera performs an imaging operation based on the synchronization signal indicating the timing of the first half of one frame, whereby imaging can be performed in the first exposure pattern. The main-camera selecting apparatus 104 also supplies the synchronization signal indicating the timing of the second half of one frame to the second main camera. The second main camera performs an imaging operation based on the synchronization signal indicating the timing of the second half of one frame, whereby imaging can be performed in the second exposure pattern.

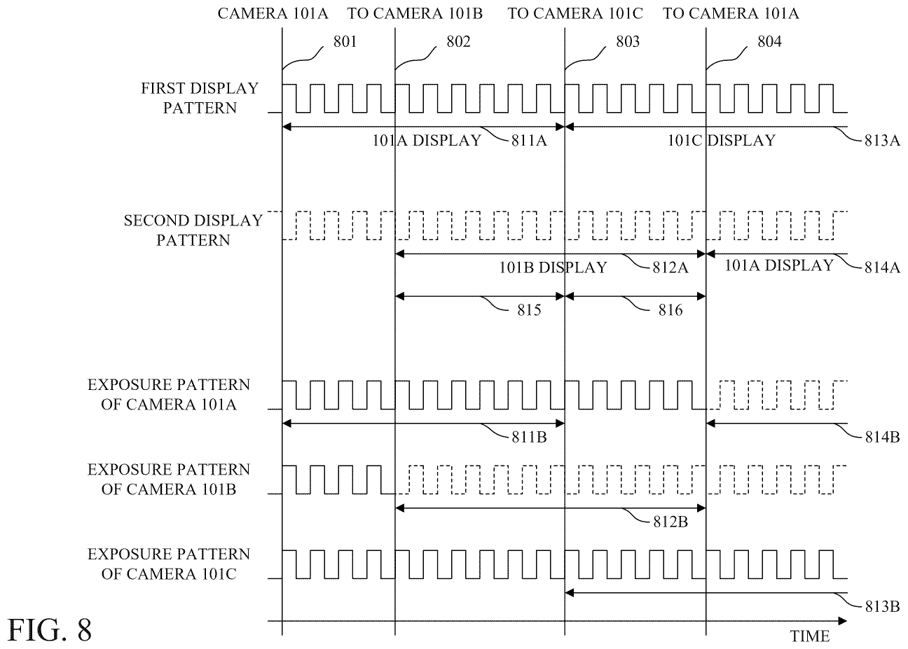

With reference to FIG. 8, an example will be described in which the display of the display apparatus 103 and the exposure patterns of the cameras 101A to 101C change in accordance with the main camera switching instruction from the user, based on the flow of FIG. 6. FIG. 8 is a diagram which illustrates examples of display patterns and exposure patterns. In FIG. 8, the assumed frequency of main camera switching instructions and a time scale of the frame rate are not matched. The horizontal axis of FIG. 8 indicates a passage of time.

A time 801 indicates a time in the initial state after the start of imaging, at which the camera 101A is set as the first main camera. A time 802 indicates a time at which the main camera switching instruction is received from the user to switch the main camera to the camera 101B. A time 803 indicates a time at which the main camera switching instruction is received from the user to switch the main camera to the camera 101C, subsequent to the time 802. A time 804 indicates a time at which the main camera switching instruction is received from the user to switch the main camera to the camera 101A, subsequent to the time 803.

A period 811A indicates a period during which the background image corresponding to the position and orientation of the camera 101A is displayed on the display apparatus 103 in the first display pattern. A period 812A indicates a period during which the background image corresponding to the position and orientation of the camera 101B is displayed on the display apparatus 103 in the second display pattern. A period 813A indicates a period during which the background image corresponding to the position and orientation of the camera 101C is displayed on the display apparatus 103 in the first display pattern. A period 814A indicates a period during which the background image corresponding to the position and orientation of the camera 101A is displayed on the display apparatus 103 in the second display pattern. Periods 811B, 812B, 813B, and 814B respectively correspond to the same periods as the periods 811A, 812A, 813A, and 814A, and indicate periods during which the background images corresponding to the respective positions and orientations of the cameras are captured by the cameras.

Here, focusing on the period 812A, changes in the display of the display apparatus 103 and in the exposure pattern of the camera 101B will be described in chronological order. At the time 802, the main-camera selecting apparatus 104 starts the display of the background image corresponding to the position and orientation of the camera 101B in the second display pattern. In addition, the main-camera selecting apparatus 104 changes the exposure pattern of the camera 101B to the second exposure pattern corresponding to the second display pattern. As a result, the camera 101B becomes capable of capturing the background image corresponding to its own position and orientation.

At the time 803, the main-camera selecting apparatus 104 starts the display of the background image corresponding to the position and orientation of the camera 101C in the first display pattern. At this time, the background image corresponding to the position and orientation of the camera 101B continues to be displayed in the second display pattern. At the time 804, the main-camera selecting apparatus 104 starts the display of the background image corresponding to the position and orientation of the camera 101A in the second display pattern, and accordingly terminates the display of the background image corresponding to the position and orientation of the camera 101B.

As a result, the camera 101B is capable of capturing background images corresponding to its position and orientation during the period 815 within the period 812A, until the main camera switching instruction is issued to switch the main camera from camera 101B to another camera. Furthermore, even during the subsequent preliminary period 816 following the period 815 within the period 812A, the camera 101B can continue to capture background images corresponding to its position and orientation.

As described above, this example illustrates an example in which, after the main camera switching instruction, the display of the background image corresponding to the position and orientation of the previously set main camera is not terminated. Accordingly, the main camera can capture the background image corresponding to its position and orientation even after the new main camera switching instruction. In addition, even when the switching time between the captured images (cuts) of the main camera before and after the main camera switching instruction is adjusted to be later than the main camera switching instruction, after the completion of capturing the in-camera VFX video, it becomes less likely that a period will occur in which the background image is not aligned.

In this example, although an example has been described in which the display of the background image corresponding to the position and orientation of a predetermined camera is continued from the start of the display until the time of the next subsequent main camera switching instruction, the display may be continued until any time as long as it is after the time of the next main camera switching instruction. In this case as well, compared with the case in which the display is continued until the next main camera switching instruction, the period during which the predetermined camera can capture the background image corresponding to its position and orientation can be extended. For example, the display of the background image corresponding to the position and orientation of the predetermined camera may be continued only for a certain period after the next main camera switching instruction. In this case, as described in Example 3 below, the main-camera selecting apparatus 104 can continue the display of the background image corresponding to the position and orientation of the predetermined camera only for the certain period by counting a predetermined time, which is the length of the preliminary period.

In this example, although an example has been described in which the number of cameras used for imaging is three and the number of time divisions for displaying the background images is two, any combination may be applied as long as the number of time divisions is smaller than the number of cameras used for imaging. In this case as well, compared with the case in which the number of time divisions for displaying the background images is equal to the number of cameras, it is possible to suppress the degree to which the exposure time of the cameras and the display time of the background images are shortened. Even when the number of time divisions is increased beyond two, it is only necessary to allocate the display periods so that each display period is included within one frame.

### Example 3

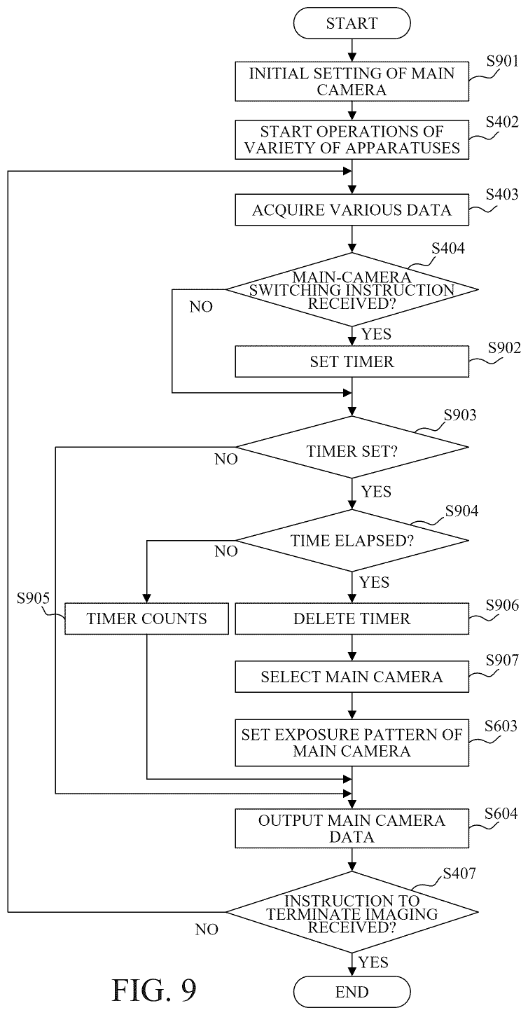

Next, with reference to FIG. 9, a description will be given of the switching operation of the main camera in Example 3 of this disclosure. FIG. 9 is a flowchart which illustrates the operation of the main-camera selecting apparatus 104 in this example.

In the main camera switching operation described in Example 2 with reference to FIG. 6, it is possible to avoid generating a period during which the background image is not aligned, even if the time of switching the cuts is adjusted to a time later than the main camera switching instruction after the imaging has been completed. On the other hand, in this example, a switching order of the main camera is registered in advance, and based on this order, the display of the background image corresponding to the next main camera is started before the main camera switching instruction. This makes it possible to avoid generating the period during which the background image is not aligned, even when the time of switching the cuts is adjusted to a time earlier than the main camera switching instruction.

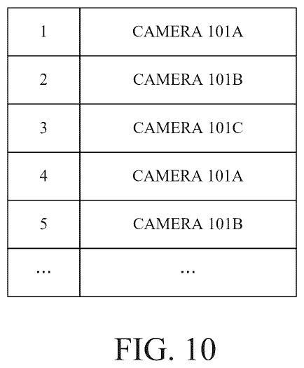

In FIG. 9, steps which execute the operations described with reference to FIG. 4 or FIG. 6 are denoted by the same reference numerals as those in FIG. 4 or FIG. 6, and descriptions thereof are omitted. Prior to the start of the flowchart of FIG. 9, the main-camera selecting apparatus 104 registers information on the switching order of the main camera as designated by the user. The information on the switching order of the main camera is, for example, a table as illustrated in FIG. 10, and includes an array designating the cameras in order. FIG. 10 is a diagram which illustrates an example of the information (table) on the switching order of the main camera.

The operation for registering the information on the switching order of the main camera by the main-camera selecting apparatus 104 will be described. The main-camera selecting apparatus 104, prior to the start of capturing the in-camera VFX video, receives an instruction to register the information on the switching order of the main camera from the user via the instruction input unit 313. At this time, the main-camera selecting apparatus 104 may also cause the display apparatus 107 to display a UI for displaying the switching order of the main camera designated by the user. Upon receiving the instruction to register the information on the switching order of the main camera from the user, the main-camera selecting apparatus 104 stores and retains the information on the switching order of the main camera in the ROM 311 or the RAM 312. In this manner, the main-camera selecting apparatus 104 is capable of registering the information on the switching order of the main camera as designated by the user.

Further, since the designation of the switching destination of the main camera is performed based on the information on the switching order of the main camera, in the example illustrated in the flowchart of FIG. 9, the main camera switching instruction does not need to include information specifying which camera is the switching destination. In the following description, the processing of the main-camera selecting apparatus 104 in steps S403 to S407 is performed for each frame based on a synchronization signal supplied from the clock generator 314, similarly to Example 1.

First, in step S901, the main-camera selecting apparatus 104 refers to the information on the switching order of the main camera and sets the initially set first main camera and second main camera. More specifically, the camera designated first in the information on the switching order of the main camera (camera 101A in the example of FIG. 10) is set as the first main camera, and the camera designated second (camera 101B in the example of FIG. 10) is set as the second main camera.

In step S404, similarly to Example 1, the main-camera selecting apparatus 104 may notify the information on the switching order of the main camera when receiving the main camera switching instruction from the user. For example, the main-camera selecting apparatus 104 may present, on the display apparatus 107, information on the next switching destination of the main camera, in accordance with the information on the switching order of the main camera and information indicating how many times the main camera switching instruction has been issued since the start of imaging.

More specifically, when receiving the first main camera switching instruction, the main-camera selecting apparatus 104 presents information indicating that, in a case where the user performs the main camera switching instruction, the main camera is switched to the camera designated in the second entry of the information on the switching order of the main camera. When receiving the second main camera switching instruction, the main-camera selecting apparatus 104 presents information indicating that, in a case where the user performs the main camera switching instruction, the main camera is switched to the camera designated in the third entry of the information on the switching order of the main camera. Similarly, when receiving the n-th main camera switching instruction, the main-camera selecting apparatus 104 presents information indicating that, in a case where the user performs the main camera switching instruction, the main camera is switched to the camera designated in the (n+1)-th entry of the information on the switching order of the main camera.

In step S404, in a case where it is determined that the main camera switching instruction has been issued, in step S902, the main-camera selecting apparatus 104 sets a timer for counting a predetermined time which is the length of the preliminary period on the rear side of the cut. More specifically, the main-camera selecting apparatus 104 adds, to the RAM 312, a variable used for counting of the timer. In addition, a value indicating the predetermined time is set to the variable. For example, in a case where the predetermined time is 2 seconds and the frame rate of the display apparatus 103 without considering time division is 60 fps, the value is set to 120.

In step S903, the main-camera selecting apparatus 104 determines whether the timer is set or not. In a case where it is determined that the timer is not set, the process proceeds to step S604. On the other hand, in a case where it is determined that the timer is set, the process proceeds to step S904.

In step S904, the main-camera selecting apparatus 104 refers to the variable used for counting of the timer, and determines whether the predetermined time has elapsed or not. More specifically, in a case where the variable value is greater than 0, it is determined that the predetermined time has not elapsed. On the other hand, in a case where the variable value is 0, it is determined that the predetermined time has elapsed. In a case where it is determined that the predetermined time has not elapsed, the process proceeds to step S905. On the other hand, in a case where it is determined that the predetermined time has elapsed, the process proceeds to step S906.

In a case where it is determined in step S904 that the predetermined time has not elapsed, in step S905, the main-camera selecting apparatus 104 causes the timer to count. More specifically, the value of the variable used for counting of the timer is decremented by 1. On the other hand, in a case where it is determined in step S904 that the predetermined time has elapsed, in step S906, the main-camera selecting apparatus 104 deletes the timer. More specifically, the variable used for counting of the timer is deleted, and the state is set such that the timer is not set.

In step S907, the main-camera selecting apparatus 104 selects the main camera according to the information on the switching order of the main camera (the start order of displaying the background image corresponding to each of the plurality of image pickup apparatuses). More specifically, the main-camera selecting apparatus 104 sets, as the main camera, the camera designated in the next entry following the entry which was set in the previous processing of step S907 among the information on the switching order of the main camera. Since the first and second entries among the information on the switching order of the main camera are already set as the main camera in the processing of step S901, in the initial processing of step S907, the camera designated in the third entry is set as the main camera. Further, when setting the main camera, the main-camera selecting apparatus 104 sets the camera to either the first main camera or the second main camera. More specifically, the main-camera selecting apparatus 104 sets the camera to the one of the first main camera and the second main camera which was not set in the previous processing of step S907. Since the camera designated in the second entry of the information on the switching order of the main camera is set as the second main camera in the processing of step S901, in the initial processing of step S907, the camera designated in the third entry is set as the first main camera.

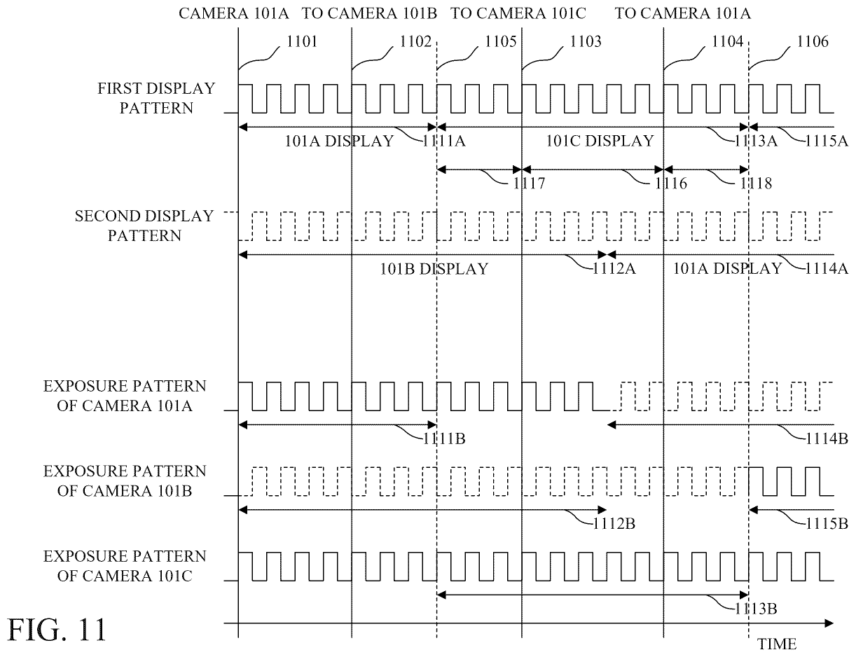

With reference to FIG. 11, an example will be described in which the display of the display apparatus 103 and the exposure patterns of the cameras 101A to 101C change in accordance with the information on the switching order of the main camera illustrated in the example of FIG. 10, and the main camera switching instruction from the user, based on the flow of FIG. 9. FIG. 11 is a diagram which illustrates an example of display patterns and exposure patterns. In FIG. 11, the assumed frequency of the main camera switching instructions and the predetermined time set in the timer in step S902 is not matched with a time scale of the frame rate. The horizontal axis of FIG. 11 indicates a passage of time.

A time 1101 indicates a time in the initial state after the start of imaging, at which the camera 101A is set as the first main camera and the camera 101B is set as the second main camera. A time 1102 indicates a time at which the first main camera switching instruction from the user is received. A time 1103 indicates a time at which the second main camera switching instruction from the user is received. A time 1104 indicates a time at which the third main camera switching instruction from the user is received.

A period 1111A indicates a period during which the background image corresponding to the position and orientation of the camera 101A is displayed on the display apparatus 103 in the first display pattern. A period 1112A indicates a period during which the background image corresponding to the position and orientation of the camera 101B is displayed on the display apparatus 103 in the second display pattern. A period 1113A indicates a period during which the background image corresponding to the position and orientation of the camera 101C is displayed on the display apparatus 103 in the first display pattern. A period 1114A indicates a period during which the background image corresponding to the position and orientation of the camera 101A is displayed on the display apparatus 103 in the second display pattern. A period 1115A indicates a period during which the background image corresponding to the position and orientation of the camera 101B is displayed on the display apparatus 103 in the first display pattern. Periods 1111B, 1112B, 1113B, 1114B, and 1115B respectively correspond to the same periods as the periods 1111A, 1112A, 1113A, 1114A, and 1115A, and indicate periods during which the background images corresponding to the respective positions and orientations of the cameras are captured by the cameras.

Here, focusing on the period 1113A, a description will be given of changes in the display of the display apparatus 103 and in the exposure pattern of the camera 101C in chronological order. The time 1105 is a time when a predetermined time, which is the length of the preliminary period on the rear side of the cut, has elapsed after the first main camera switching instruction at the time 1102. At the time 1105, the main-camera selecting apparatus 104 refers to the third entry in the information on the switching order of the main camera illustrated in FIG. 10, and starts displaying the background image corresponding to the position and orientation of the camera 101C in the first display pattern. The main-camera selecting apparatus 104 also changes the exposure pattern of the camera 101C to the first exposure pattern corresponding to the first display pattern. This allows the camera 101C to capture the background image corresponding to its own position and orientation.

The time 1103 is a time when the second main camera switching instruction is received. The main-camera selecting apparatus 104, after the lapse of the predetermined time, refers to the fourth entry in the information on the switching order of the main camera illustrated in FIG. 10, and starts displaying the background image corresponding to the position and orientation of the camera 101A in the second display pattern. At this time, the background image corresponding to the position and orientation of the camera 101C continues to be displayed in the first display pattern. In addition, when the second main camera switching instruction is received, the main-camera selecting apparatus 104 presents information indicating that, in a case where the user issues the main camera switching instruction, the main camera is switched to the camera 101C, which is designated in the third entry of the information on the switching order of the main camera. Therefore, the main-camera selecting apparatus 104 can cause the user to recognize that the main camera is switched to the camera 101C by the main camera switching instruction at the time 1103.

The time 1104 is a time when the third main camera switching instruction is received, and the main-camera selecting apparatus 104 starts counting the predetermined time. In addition, when the third main camera switching instruction is received, the main-camera selecting apparatus 104 presents information indicating that, in a case where the user issues the main camera switching instruction, the main camera is switched to the camera 101A, which is designated in the fourth entry of the information on the switching order of the main camera. Therefore, the main-camera selecting apparatus 104 can cause the user to recognize that the main camera is switched to the camera 101A by the main camera switching instruction at the time 1104.

The time 1106 is a time at which the predetermined time has elapsed from the time 1104, and the main-camera selecting apparatus 104 refers to the fifth entry of the information on the switching order of the main camera illustrated in FIG. 10, and starts displaying, in the first display pattern, the background image corresponding to the position and orientation of the camera 101B. In accordance with this, the main-camera selecting apparatus 104 terminates the display, in the first display pattern, of the background image corresponding to the position and orientation of the camera 101C.

Accordingly, the camera 101C is capable of capturing the background image corresponding to its position and orientation during the period 1116, which is a period within the period 1113A, in which the main-camera selecting apparatus 104 prompts the user to recognize that the main camera is the camera 101C. In addition, the camera 101C is capable of capturing the background image corresponding to its position and orientation even during the preliminary period 1117, which precedes the period 1116, within the period 1113A, prior to the main camera switching instruction at time 1103. Further, the camera 101C is capable of continuously capturing the background image corresponding to its position and orientation even during the preliminary period 1118, which is a period within the period 1113A, which follows the period 1116.

As described above, in this example, an example is illustrated in which the switching order of the main camera is registered in advance, and based on this order, the display of the background image corresponding to the target main camera is started before the main camera switching instruction. As a result, a predetermined camera is capable of capturing the background image corresponding to its position and orientation from a time earlier than the time of the main camera switching instruction (i.e., the time presented to the user as the timing at which the corresponding camera is set as the main camera. Furthermore, even if the switching time of the captured images (cuts) between the main camera before the main camera switching instruction and the main camera after the main camera switching instruction is adjusted to a time earlier than the main camera switching instruction after the completion of capturing the in-camera VFX video, it becomes less likely that a period will occur in which the background image is not aligned.

In this example, although an example has been described in which the preliminary period is provided both before and after the period (cut) during which the user is caused to recognize that a predetermined camera is the main camera, this disclosure is also applicable in the case where the preliminary period is provided only before the period. In this case, by setting the predetermined time to 0 seconds in the flowchart of FIG. 9, it is possible to provide the preliminary period only before the cut.

In the flowchart of FIG. 9, although an example has been described in which the main-camera selecting apparatus 104 switches the main camera after the lapse of the predetermined time from the reception of the main camera switching instruction, thereby providing the preliminary period on the rear side of the cut, the length of the predetermined time may be settable by the user. In this case, the main-camera selecting apparatus 104 receives a setting of the length of the predetermined time from the user via the instruction input unit 313 before the start of capturing the in-camera VFX video. Further, information on the length of the predetermined time specified by the user is stored and held in the ROM 311 or the RAM 312, and this information is referred to in the processing of step S902. Accordingly, the user can adjust the balance between the preliminary period on the rear side of the cut and the length of the preliminary period on the front side of the cut, which becomes shorter as the rear-side preliminary period becomes longer.

Further, processing to be performed when a next main camera switching instruction is received before the lapse of the predetermined time after receiving the main camera switching instruction may be added to the flowchart of FIG. 9. More specifically, the main-camera selecting apparatus 104 performs switching of the main camera at whichever of the following timings comes first: when the predetermined time has elapsed after receiving the main camera switching instruction, or when the next main camera switching instruction is received. Accordingly, even when the next main camera switching instruction is received before the predetermined time has elapsed, the main-camera selecting apparatus 104 can more easily perform the switching of the main camera at the timing instructed by the user.

In this example, although an example has been described in which the number of cameras used for imaging is three and the number of time divisions for displaying background images is two, any combination is applicable as long as the number of time divisions is less than the number of cameras used for imaging. Even in this case, as compared with a case in which the number of time divisions for displaying background images is equal to the number of cameras, it is possible to suppress the degree to which the exposure time of the cameras and the display time of the background images are shortened.

As described above, the control apparatus (104) according to each example is a control apparatus of the imaging system 100 which captures each of the background images displayed on the display apparatus 103 using a plurality of image pickup apparatuses (cameras 101A to 101C) including the first image pickup apparatus and the second image pickup apparatus. The control apparatus includes, for example, at least one of the main-camera selecting apparatus 104, the background-image generating apparatus 105, the display control apparatus 106, and the display apparatus 107, but is not limited thereto.

The control apparatus includes a controller (control unit 301) and a processor (instruction input unit 313). The controller causes a display apparatus to display a first background image corresponding to a first position and orientation of a first image pickup apparatus (one of the plurality of image pickup apparatuses) and a second background image corresponding to a second position and orientation of a second image pickup apparatus (another one of the plurality of image pickup apparatuses). The processor acquires a start instruction from a user to start displaying the second background image on the display apparatus while the first background image is being displayed on the display apparatus. The controller starts displaying the second background image on the display apparatus according to the start instruction.

In each example, the processor acquires the start instruction from the user to start displaying the second image pickup apparatus via an operation unit for allowing the user to select or specify one image pickup apparatus (the second image pickup apparatus) from among the plurality of image pickup apparatuses. However, the present disclosure is not limited thereto. For example, the plurality of image pickup apparatuses constituting the imaging system 100 and an order of display switching may be registered in advance according to user settings. In this case, the processor can acquire the start instruction for the second image pickup apparatus in the registered start order each time the user operates the operation unit (e.g., each time a specific button is pressed). The processor may also acquire the start instruction via wired or wireless communication according to a user operation through an operation unit which is disposed at a location physically separate from other components such as the control unit 301, instead of through the operation unit disposed at the same location as the other components.

In each example, the start instruction from the user is not limited to an instruction directly acquired based on the user operation via the operation unit. For example, the user may register (set) in advance a timing (time) of the start instruction, and the controller may start displaying the second background image by determining that the start instruction has been issued when the registered time is reached. Such a configuration is also included in a configuration in which the processor acquires the start instruction from the user and the controller starts displaying the second background image according to the start instruction.

In each example, the controller may include an automatic mode related to the start instruction from the user, for example, by utilizing Artificial Intelligence (AI). In this case, the start instruction acquired in the automatic mode can be regarded as the start instruction from the user. That is, in a case where the automatic mode is set, the processor can automatically acquire the start instruction (start instruction from the user in the automatic mode) at an appropriate timing based on various kinds of information, such as the position and orientation of each of the plurality of image pickup apparatuses, time, or displayed video. The controller is capable of starting displaying the second background image in accordance with the start instruction from the user in the automatic mode.

In each example, although the controller starts the display of the second background image at the timing of the start instruction, the present disclosure is not limited thereto. A predetermined time difference may occur between the timing of the start instruction and the start timing of the display of the second background image, and the length of this time difference may be arbitrary. Further, the user may arbitrarily set or change the time difference. This makes it possible to enhance convenience for each user. That is, it is sufficient that the second background image is displayed according to the start instruction from the user, and the interval between the timing of the start instruction and the start timing of the display of the second background image can be appropriately set.

The controller may terminate the display of the first background image according to the start instruction. Also, the controller may acquire a first captured image captured by the first image pickup apparatus and a second captured image captured by the second image pickup apparatus. Then, the controller may select, at a first time at which the first background image is displayed on the display apparatus, the first captured image which was captured at the first time. The controller also may select, at a second time at which the second background image is displayed on the display apparatus, the second captured image which was captured at the second time. The display apparatus 107 may display the first captured image or the second captured image selected by the control unit.

Each example can provide a control apparatus, an imaging system, a control method, and a storage medium, each of which can acquire a video with a favorable visual effect regardless of the number of image pickup apparatuses.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-159080, filed Sep. 13, 2024, which is hereby incorporated by reference herein in its entirety.

What is claimed is:

1. A control apparatus for an imaging system configured to capture background images displayed on a display apparatus by using a plurality of image pickup apparatuses including a first image pickup apparatus and a second image pickup apparatus, the control apparatus comprising:
one or more memories storing instructions; and
one or more processors that, upon execution of the instructions, operate to:
cause the display apparatus to display a first background image corresponding to a first position and orientation of the first image pickup apparatus and a second background image corresponding to a second position and orientation of the second image pickup apparatus, and
acquire a start instruction from a user to start display of the second background image on the display apparatus while the first background image is being displayed on the display apparatus,
wherein the one or more processors operate to start the display of the second background image on the display apparatus according to the start instruction.

2. The control apparatus according to claim 1, wherein the one or more processors operate to terminate display of the first background image according to the start instruction.

3. The control apparatus according to claim 1, wherein the one or more processors operate to:
acquire a first captured image captured by the first image pickup apparatus and a second captured image captured by the second image pickup apparatus,
select, at a first time when the first background image is displayed on the display apparatus, the first captured image captured at the first time, and
select, at a second time when the second background image is displayed on the display apparatus, the second captured image captured at the second time.

4. The control apparatus according to claim 1, wherein the one or more processors operate to start the display of the second background image on the display apparatus by changing information on the first position and orientation to information on the second position and orientation according to the start instruction.

5. The control apparatus according to claim 1, wherein the one or more processors operate to change, according to the start instruction, a first imaging range of the first image pickup apparatus on a display surface of the display apparatus to a second imaging range of the second image pickup apparatus.

6. The control apparatus according to claim 3, wherein the one or more processors operate to determine whether or not the second captured image has been captured at a display time of the second background image.

7. The control apparatus according to claim 6, wherein the one or more processors operate to attach to the second captured image, information indicating whether or not the second captured image has been captured at the display time of the second background image.

8. The control apparatus according to claim 6, wherein the one or more processors operate to extract from among the second captured images, a captured image which has been captured at the display time of the second background image, using information indicating whether or not the second captured image has been captured at the display time of the second background image.

9. The control apparatus according to claim 1, wherein the one or more processors operate to set on the display apparatus, a first display period of the first background image and a second display period of the second background image, which do not overlap each other.

10. The control apparatus according to claim 9, wherein the one or more processors operate to set the first display period and the second display period within one frame period.

11. The control apparatus according to claim 9, wherein the number of a plurality of display periods including the first display period and the second display period is smaller than the number of the plurality of image pickup apparatuses.

12. The control apparatus according to claim 9, wherein the one or more processors operate to control the display apparatus so as to display the first background image in the first display period and to display the second background image in the second display period.

13. The control apparatus according to claim 12, wherein the one or more processors operate to control the second image pickup apparatus so that the second display period is included in an exposure period of the second image pickup apparatus and the first display period is not included in the exposure period.

14. The control apparatus according to claim 12, wherein the one or more processors operate to continue, after causing the display apparatus to start the display of the second background image according to the start instruction, display of the first background image for a predetermined period.

15. The control apparatus according to claim 14, wherein the predetermined period is a period until display of a third background image, which is different from the first background image, is started in the first display period.

16. The control apparatus according to claim 14, further comprising a setting unit configured to allow a user to set in advance a start order of displays of the background images of the plurality of image pickup apparatuses,
wherein the one or more processors operate to start the display of the background images according to the start order.

17. A control method for an imaging system configured to capture background images displayed on a display apparatus by using a plurality of image pickup apparatuses including a first image pickup apparatus and a second image pickup apparatus, the control method comprising:
causing the display apparatus to display a first background image corresponding to a first position and orientation of the first image pickup apparatus and a second background image corresponding to a second position and orientation of the second image pickup apparatus; and
acquiring a start instruction from a user to start display of the second background image on the display apparatus while the first background image is being displayed on the display apparatus,
wherein in the display, the display of the second background image on the display apparatus is started according to the start instruction.

18. An imaging system comprising:
a first image pickup apparatus;
a second image pickup apparatus;
a display apparatus; and
the control apparatus according to claim 1.

19. A non-transitory computer-readable storage medium storing a program for causing a computer to execute the control method according to claim 18.
